(19) United States
(12) Patent Application Publication
(10) Pub. No.: US 2015/0081901 A1
(43) Pub. Date: Mar. 19, 2015

(54) POWER STATE SYNCHRONIZATION

(71) Applicant: Broadcom Corporation, Irvine, CA (US)

(72) Inventor: Shubham Saloni, BANGALORE (IN)

(73) Assignee: Broadcom Corporation, Irvine, CA (US)

(21) Appl. No.: 14/041,442

(22) Filed: Sep. 30, 2013

Related U.S. Application Data
(60) Provisional application No. 61/879,964, filed on Sep. 19, 2013.

(51) Int. Cl. H04L 12/911

(52) U.S. Cl. CPC H04L 47/70
USPC 709/225

(57) ABSTRACT

Aspects of power state synchronization are described. In one embodiment, a device is operated as a group access point in a network. Using the group access point, a network including a plurality of devices is established. In operation, the group access point receives a standby entry indicator from a first device of the plurality of devices. In response, the group access point communicates a halt indicator to at least a second device of the plurality of devices. In various embodiments, the halt indicator indicates a halt of communications to the first device. By halting communications, packet loss by the group access point may be avoided, and data throughput in the network may be optimized. In other aspects, the group access point may receive a standby exit indicator from the first device and, in response, communicate a communications resume indicator to at least the second device.

### CROSS-REFERENCE TO RELATED APPLICATIONS

This application claims the benefit of U.S. Provisional Application No. 61/879,964, filed Sep. 19, 2013, the entire contents of which is hereby incorporated herein by reference.

### BACKGROUND

Many electronic devices, such as cellular telephones, smartphones, tablet computing devices, desktop and laptop computers, portable gaming devices, etc., include circuitry that facilitates communications according to various standards or specifications. For example, a cellular telephone may communicate according to Global System for Mobile (“GSM”), Code Division Multiple Access (“CDMA”), Long Term Evolution (“LTE”), etc., or other cellular services, and/or variations thereof. The cellular telephone may further communicate according to Bluetooth® (“BT”) and Wireless Local Area Network (“WLAN”) (e.g., 802.11-based “WiFi”, 802.16 “WiMAX”) standards or services, among others.

Often, a group of electronic devices may operate in a network in which data may be communicated among the devices in the network. For example, a wireless WLAN network may be operated among several devices. In this case, data, such as data files, video or audio content, or digital images, for example, may be communicated among the devices. In one network topology, one of the devices in the network may operate as an access point, switch, and/or router. According to certain aspects, the access point may coordinate communications among and facilitate communications between the devices in the network.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates a system for communications according to an example embodiment.

FIG. 2 illustrates a system for power state synchronization according to an example embodiment.

FIG. 3A illustrates a flow diagram for a process of power state synchronization performed by the system of FIG. 1 according to an example embodiment.

FIG. 3B further illustrates a flow diagram for the process of power state synchronization according to an example embodiment.

FIG. 4 illustrates an example schematic block diagram of a computing environment which may be employed in the system of FIG. 2 according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions or positions of elements and features may be exaggerated to help visually convey certain principles. In the drawings, similar reference numerals between figures designate like or corresponding, but not necessarily the same, elements.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments.

Using communications services, a group of electronic devices may operate in a network in which data is communicated among the devices. For example, a wireless WLAN or wired Local Area Network (“LAN”) may be operated among several devices. In this case, data, such as data files, video or audio content, or digital images, for example, may be communicated among the devices. In various WLAN network topologies, one of the devices in the network may be embodied as an access point, network switch, and/or router (i.e., “access point”). According to certain aspects, such an access point may coordinate and facilitate communications among and between the devices in the network. In this context, the access point may allow client devices to connect to a local WLAN and provide a link to a broader local or enterprise-level network and, sometimes, the Internet. The access point may be further relied upon to establish and enforce data security and encryption settings, passwords, and other parameters for secure wireless communications access.

In certain situations, no specific-purpose access point is available to establish network communications among devices. In this case, other network topologies may be relied upon to establish network connectivity among devices. For example, ad-hoc network topologies (i.e., “P2P network topologies”), such as Wi-Fi Direct or P2P-go, among others, enable peer-to-peer (“P2P”) connectivity. These P2P network topologies are designed to connect devices to each other without, for example, the need for a specific-purpose access point. P2P network topologies may be particularly helpful when the goal is communication of data between a relatively small number of devices, and no access to a broader network or the Internet is needed. For example, the user of a wireless-enabled camera or video recorder may wish to print or display a photo to a wireless-enabled display device. As another example, users of one or more wireless-enabled cellular telephones may wish to stream or transfer videos, photos, music, or other content from a wireless-enabled laptop computer.

Using P2P network topology, one-to-one or one-to-multiple links may be established between devices. Generally, one device assumes ownership of the link. This device may be identified as the P2P group owner, and clients to the P2P group owner may be identified as P2P client devices. Typically, the P2P group owner includes support for P2P connectivity in the form of additional software and/or hardware to support the additional functions, protocols, and features of the standard. To a certain extent, when relying upon the additional software and/or hardware to support P2P network topology, a P2P group owner operates in a manner which is similar, in part, to a specific-purpose access point. It should be recognized, however, that a P2P group owner may not include or incorporate the same hardware elements of a specific-purpose access point. To save costs, for example, a P2P group owner may not include a large data buffer.

It is also noted that P2P network topologies, and particularly wireless-enabled P2P network topologies, may rely upon certain power savings and management protocols. These power savings and management protocols may be especially useful for battery powered devices. As one example power savings protocol feature, one or more P2P clients may enter a sleep mode for a period of time. During this period of time, the P2P group owner may buffer a certain amount of data for communication after the P2P clients exit the sleep mode. The amount of data that may be buffered by the P2P group owner may depend, at least in part, upon the available memory of the P2P group owner, which is often less than the available memory in specific-purpose access points.

In the context outlined above, aspects of power state synchronization are described herein. In one embodiment, a device is operated as a group access point in a network. Using the group access point, a network including a plurality of devices is established. In operation, the group access point receives a standby entry indicator from a first device of the plurality of devices. In response, the group access point communicates a halt indicator to at least a second device of the plurality of devices. In various embodiments, the halt indicator indicates a halt of communications to the first device. By halting communications, packet loss by the group access point may be avoided, and data throughput in the network may be optimized. In other aspects, the group access point may receive a standby exit indicator from the first device and, in response, communicate a communications resume indicator to at least the second device.

Turning now to the drawings, a description of exemplary embodiments of a system and its components are provided, followed by a discussion of the operation of the same.

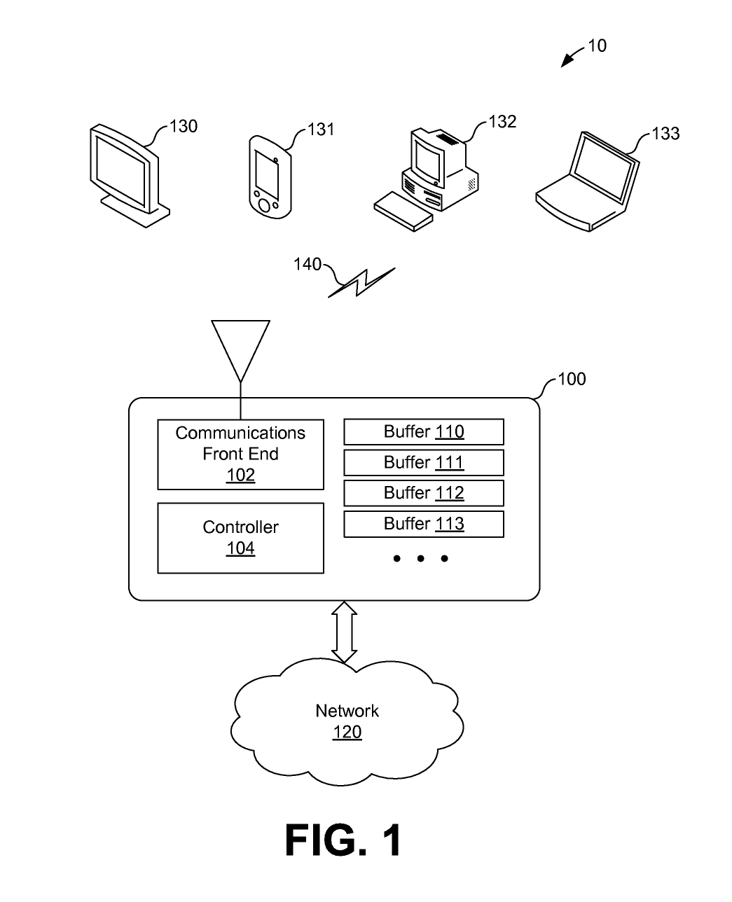

FIG. 1 illustrates a system 10 for communications according to an example embodiment. The system 10 includes an access point 100, a network 120 coupled to the access point 100, and a plurality of devices 130-133. In the system 10, the plurality of devices 130-133 are communicatively coupled to the access point 100, forming a communications network 140 in which data may be communicated among the devices 130-133. Additionally, by the access point 100, the devices 130-133 are communicatively coupled to the network 120, which may include a local or enterprise-level network and/or the Internet, for example. Although the communications network 140 in FIG. 1 is illustrated as a wireless (e.g., BT, Wi-Fi, WiMAX, etc.) network, the system 10 may rely upon a wired network, as the features and aspects of power state synchronization described herein may be applicable to both wireless and wired network topologies. Further, it is noted that the wireless communications network 140 may be embodied as any suitable type of wireless network, relying upon any suitable standard and/or protocol for communications.

In various embodiments, the plurality of devices 130-133 include a display 130, a cellular telephone 131, a desktop computer 132, and a laptop computer 133. The devices 130-133 illustrated in FIG. 1 are representative and provided by way of example only, and it should be appreciated that other devices may be used in the system 10. For example, camera, printer, tablet, set-top box, portable music player, and other computing devices may be used in the system 10, without limitation.

Generally, each of the plurality of devices 130-133 includes one or more processing circuits, one or more memories, and one or more elements to support networked communications via the communications network 140. For example, each of the plurality of devices 130-133 may include a physical layer (“PHY”) radio frequency (“RF”) front end circuit that supports wireless communications between the device and the access point 100. In this context, each front end circuit may include one or more antennas, amplifiers, mixers, duplexers, and filter circuits, for example, to support wireless communications via the communications network 140 using one or more suitable communications standard or protocol. Further, in certain aspects and embodiments, each of the plurality of devices 130-133 stores computer-readable application and/or driver instructions in memory. The instructions may be executed by processing circuits of the devices 130-133, for support of certain operations or functions of the devices 130-133. In other embodiments, the operations or functions of the devices 130-133 may be embodied in Application Specific Integrated Circuits (ASICs), or combinations of executed instructions and ASIC circuits. In this context, it should be appreciated that each of the plurality of devices 130-133 may operate among various abstraction layers of the Open Systems Interconnection (“OSI”) model, for example.

In the example embodiment of FIG. 1, the access point 100 is embodied as an access point of the communications network 140. Generally, the access point 100 is designed to coordinate and facilitate communications among and between the plurality of devices 130-133 via the communications network 140. Among other elements, the access point 100 includes a communications front end 102, a controller 104, and buffers 110-113. The communications front end 102 is similar to the front end circuitry of the plurality of devices 130-133, at least to the extent that the communications front end 102 supports wireless communications. In this context, the communications front end 102 may include one or more antennas, amplifiers, mixers, duplexers, and filter circuits, for example, to support wireless communications via the communications network 140.

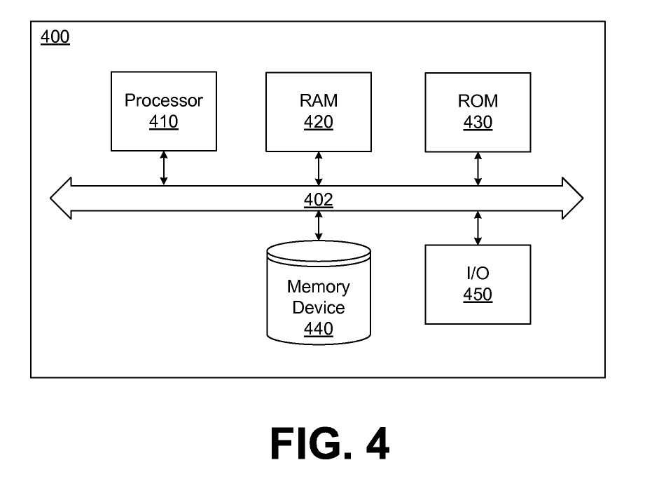

The controller 104 of the access point 100 includes a processing circuit configured to coordinate operations of the access point 100. As such, the controller 104 may be embodied as an ASIC, a general purpose processing circuit configured by the execution of computer-readable instructions, other circuitry and/or logic elements, or any combination thereof, for example. Further example aspects of the controller 104 are described below with reference to FIG. 4.

When facilitating communications among the plurality of devices 130-133, the access point 100 may store data in one or more of the buffers 110-113. For example, when data is communicated from the network 120 to the device 130, the access point 100 may store the data in the buffer A 110, while awaiting for access over the communications network 140 to transfer the data to the device 130. Similarly, when data is communicated from the device 131 to the device 133, for example, the access point 100 may store the data in the buffer B 111, while awaiting access to the communications network 140 for data transfer. In this context, it is noted that the buffers 110-113 may be embodied as any memory suitable for storing data.

It is noted here that, because the access point 100 is designed for use as a coordinator in the communications network 140, the access point 100 is generally designed to facilitate data transfer among the plurality of devices 130-133. As such, the buffers 110-113 are typically designed to be of suitable memory size for buffering data, as needed, even in the case of significant congestion in the communications network 140. That is, the buffers 110-113 may be relied upon by the access point 100 to temporarily store data, while awaiting for access over the communications network 140, without dropping packets. In one embodiment, the buffers 110-113 are used to buffer data for the plurality of devices 130-133, respectively. It is noted, however, that various numbers and arrangements of the buffers 110-113 are within the scope and spirit of the embodiments described herein.

The access point 100 may additionally facilitate features of the network protocol(s) (e.g., BT, WiFi, WiMAX, etc.) supported upon by the access point 100. As one example feature, the access point 100 may be configured to facilitate power management modes of operation for the plurality of devices 130-133. According to one power management mode, for example, one or more of the plurality of devices 130-133 may indicate to the access point 100 that the device is entering a sleep state. During this sleep state, the access point 100 may buffer data in one or more of the buffers 110-113. This buffered data may be transmitted by the access point 100 to the devices after the devices wake from the sleep state. According to certain protocols, it may be necessary for sleeping devices to periodically wake for the receipt of an Announcement Traffic Indication Message (“ATIM”) beacon, for example, transmitted from the access point 100. Using to the beacon, the access point 100 may indicate for the devices 130-133 whether data is buffered at the access point 100 for communication. If the devices 130-133 do not acknowledge the ATIM beacon and wake for data communication, then data stored by the access point 100 may be deleted or overwritten by the access point 100.

Among other problematic conditions, such as packet loss, failure of one of the devices 130-133 to wake for data communication may result in a rate fallback adaptation by the access point 100. That is, the access point 100 may determine that one or more of the devices 130-133 cannot facilitate communications at a certain data rate, and select a lower rate for communications. In other cases, the access point 100 may disassociate with one or more of the devices 130-133.

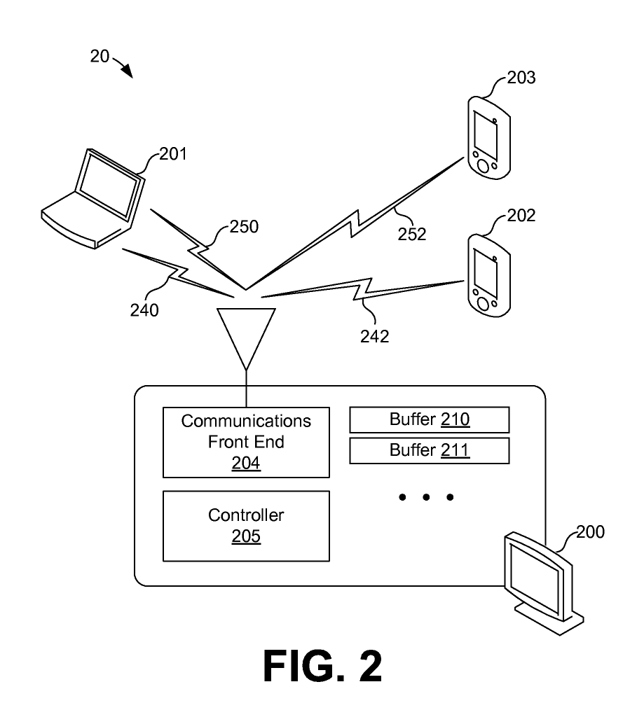

Turning to FIG. 2, a system 20 for power state synchronization according to an example embodiment is illustrated. The system 20 includes a plurality of devices 200-203 which form and are communicatively coupled by an ad-hoc or P2P network. Among the plurality of devices 200-203 in the example system 20, the device 200 is embodied as a display device, such as a television or computer monitor, and is configured as a P2P group owner of the P2P network. The other devices 201-203 are P2P client devices and are embodied as a laptop computer 201, and cellular telephones 202 and 203, although the plurality of devices 200-203 could be embodied as other types of computing devices. Generally, the plurality of devices 200-203 in FIG. 2 are similar to the plurality of devices 130-133 in FIG. 1, at least to the extent that each of the devices are capable of data communications in a network.

As noted above, the device 200 is configured as the P2P group owner in the system 20, and the devices 201-203 are P2P client devices. In various aspects of the embodiments, the device 200 may be configured as the P2P group owner by way of configuration of certain settings of the device 200. Generally, any of the devices 200-203 may be configured as a P2P group owner, for example, based on the configuration of additional software and/or hardware to support the functions, protocols, and features of a P2P group owner. It is noted that the device 200, at least in part, operates in a manner which is similar to the access point 100 of FIG. 1. However, because a primary consideration in the design of the device 200 is, for example, display functionality, the device 200 may not include the same hardware elements of the access point 100. For example, the device 200, while including a data buffer and/or various memories, may not include a buffer capable of storing sufficient data for communication among the devices 200-203 while also avoiding packet loss in congested networks. Stated differently, given the same amount of network traffic, the P2P group owner device 200 in FIG. 2 may be more likely to drop packets than the access point 100 in FIG. 1.

The P2P group owner device 200 includes a communications front end 204, a controller 205, and buffers 210 and 211. In certain aspects, the communications front end 204 is similar to the communications front end 102 of the access point 100 of FIG. 1. Additionally, at least to the extent that the devices support networked communications, each of the devices 201-203 includes a communications front end similar to the communications front end 204. The controller 205 includes a processing circuit configured to coordinate operations of the P2P group owner device 200. As such, the controller 205 may be embodied as an ASIC, a general purpose processing circuit configured by the execution of computer-readable instructions, other circuitry and/or logic elements, or any combination thereof, for example. Further example aspects of the controller 205 are described below with reference to FIG. 4.

In operation, the P2P group owner device 200 may be configured or directed (e.g., by the controller 205) to establish a network including one or more communications channels among the plurality of devices 200-203. In the context of the example illustrated in FIG. 2, the communications channels include link paths 240 and 242 between the device 201 and the device 202, and link paths 250 and 252 between the device 201 and the device 203. The communications channels illustrated in FIG. 2 may be relied upon to stream or transfer videos, photos, music, or other content or data from the wireless-enabled laptop computer 201 to the wireless-enabled cellular telephones 202 and 203, respectively, with the P2P group owner device 200 coordinating and/or facilitating the transfer.

In one aspect, the devices 200-203 in the system 20 of FIG. 2 may enter a power save or sleep mode of operation. To enter the sleep mode of operation, for example, the device 202 may communicate a standby entry indicator to the P2P group owner device 200. In turn, the P2P group owner device 200 may receive the standby entry indicator from the device 202. In turn, the P2P group owner device 200 may communicate a halt indicator to one or more of the other devices 201-203 in the system 20. The halt indicator may indicate a halt of further communications to the device 202. In various embodiments, the halt indicator may indicate a halt of further communications to the device 202 for certain predetermined or configured period of time, or until a resume indicator is communicated.

By instructing other devices in the system 20 to halt further communications to the device 202, the P2P group owner device 200 may avoid overflow of one or more of the buffers 210 or 212, preventing packet or data loss. It should be appreciated here that, as compared to the system 10 of FIG. 1, in which the access point 100 buffers data for devices which enter sleep mode, the P2P group owner device 200 is configured to communicate halt indicators to one or more devices in the system 20 to halt certain communications. In certain aspects further described below, the P2P group owner device 200 may also buffer a relatively limited amount of data on behalf of a device which enters sleep mode. The use of halt indicators may be particularly useful when one or more of the devices 200-203 are configured for use as a P2P group owner device in an ad-hoc network, because the devices 200-203 may not be designed for buffering significant amounts of data for several devices. Thus, buffer overflow packet loss may be avoided.

In addition to avoiding buffer overflow packet loss, the communications channels may be more efficiently and effectively utilized according to aspects of the embodiments described herein. For example, it is noted that the link paths 240, 242, 250, and 252 must share the communications resources in the network. Consider, for example, a condition in which the device 201 is streaming one or more videos to the devices 202 and 203, respectively, via the link paths 240 and 242 and 250 and 252. If the device 202 enters a sleep mode (i.e., traffic on link 242 is substantially reduced) and the P2P group owner device 200 does not halt the video stream from the device 201 to the device 202 (i.e., over the remaining link 240), then one or more of the buffers 210 and/or 211 of the P2P group owner device 200 may overflow. In this case, any data that overflows at the P2P group owner device 200 may be considered to be lost, and the continued use of the link 240 may be considered a waste of communications resources in the network. On the other hand, if the P2P group owner device 200 halts the video stream from the device 201 to the device 202, then data throughput on over the link 250 (and the link 252) may be increased. That is, the P2P group owner device 200 may increase data throughput on one or more link paths after communication of a halt indicator.

Among embodiments, the P2P group owner device 200 may communicate the halt indicator in a certain type of frame, based on certain considerations. For example, the P2P group owner device 200 may determine a frame type for communication of the halt indicator based on a frequency of receipt of standby entry indicators from the devices 201-203. One of various types of frames, such as action or beacon frames, for example, may be selected for communication of halt indicators. The type of frame may be selected based on how frequently the devices 201-203 enter standby mode. In one embodiment, if the devices 201-203 enter standby mode relatively frequently, beacon frames may be used for communication of halt indicators. On the other hand, if the devices 201-203 enter standby mode relatively less frequently, action frames may be used. In this manner, either beacon or action frames may be relied upon based on certain considerations, with an aim to increase data throughput and prevent network congestion, delay, or data loss, for example. Although beacon and action frames are described, it should be appreciated that other types of frames defined by various communications protocols may be relied upon for the communication of halt indicators. These frames may be selected based on various considerations consistent with the scope and spirit of the embodiments described herein.

Within the frames relied upon for the communication of halt indicators, one or more identifiers of the devices which have entered standby mode may be inserted. For example, media access control (“MAC”) addresses of one or more of the devices 201-203 that have entered standby mode may be inserted into an action frame or beacon frame. In turn, other (non-standby mode) ones of the devices 201-203 may identify the MAC addresses of the identified standby mode devices, and halt further communications to them. In other embodiments, a frame may include an indication that, for example, the device 201 should halt communications to the device 202, but not that the device 203 should halt communications to the device 202. In other words, a halt indicator may specify that all devices halt communications to an identified device, that an identified device halt communications to all devices, or that an identified device halt communications to another identified device.

According to other aspects, before communicating a halt indicator for the device 202, for example, the P2P group owner device 200 may estimate a time period which is needed to resume communications to the device 202. That is, the P2P group owner device 200 may estimate a time period which is needed to resume communications to the device 202 after the device 202 transmits a standby exit indicator to the P2P group owner device 200. Based on the estimated time period, the P2P group owner device 200 may buffer a predetermined amount of data on behalf of the device 202, before communicating a halt indicator which indicates a halt of communications to the device 202. In this manner, the P2P group owner device 200 may buffer a limited amount of data, so as to commence data communication to the device 202 immediately after receipt of a standby exit indicator from the device 202 and while the device 201, for example, resumes data communication to the device 202. The time period to resume may be estimated by the P2P group owner device 200 based on various factors, such as current network traffic and congestion, negotiated data rates among the devices 200-203, and typical or expected protocol latencies, for example.

The P2P group owner device 200 is further configured to receive a standby exit indicator. For example, at some time after receipt of the standby entry indicator from the device 202, the P2P group owner device 200 may receive a standby exit indicator from the device 202. In turn and in response to receipt of the standby exit indicator, the P2P group owner device 200 may communicate a communications resume indicator to one or more of the devices 201-203 in the system 20. The resume indicator may indicate a resumption of communications to the device 202. It should be noted here that, in various embodiments, the resume indicator may be embodied as an actual resume command, for example, or the lack of the indication to halt communications. In other words, if a halt indicator is embodied as a MAC address of a device to which communications should be halted, the resume indicator may be embodied as the omission of such MAC address from a communicated frame. It is additionally noted that, a resume indicator may specify that all devices resume communications to an identified device, that an identified device resume communications to all devices, or that an identified device resume communications to another identified device.

Here, it is noted that aspects of the embodiments described in connection with the system 20 of FIG. 2 may be practiced in connection with the system 10 of FIG. 1. For example, the access point 100 may communicate halt indicators and resume indicators when one or more of the devices 130-133 enter and exit sleep modes or states. In this context, the communications network 140 may be more efficiently and effectively utilized.

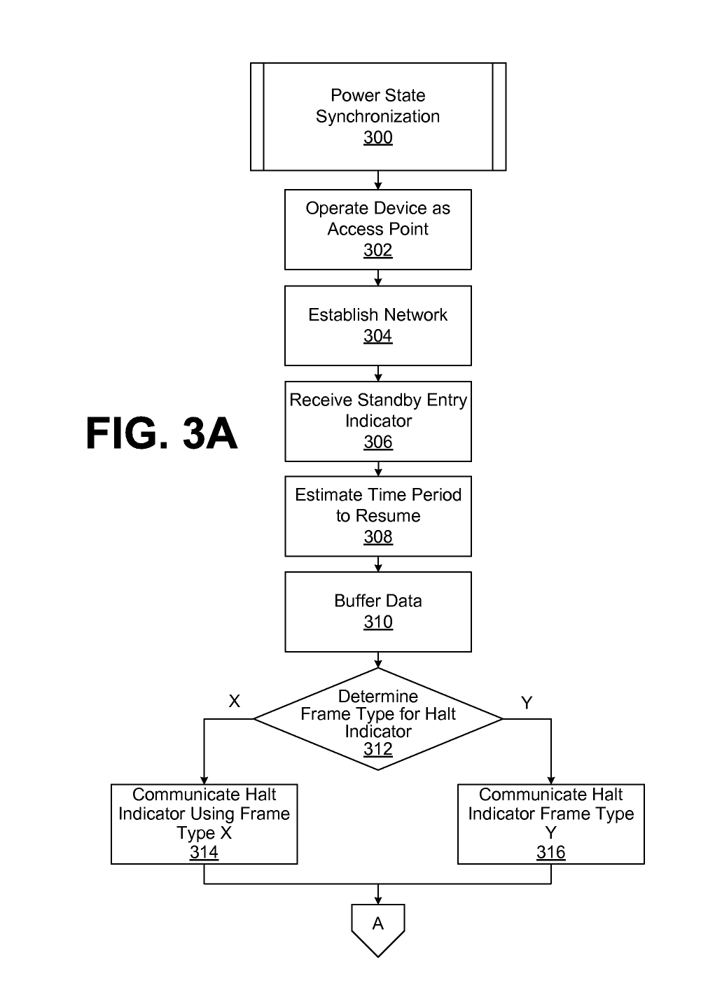

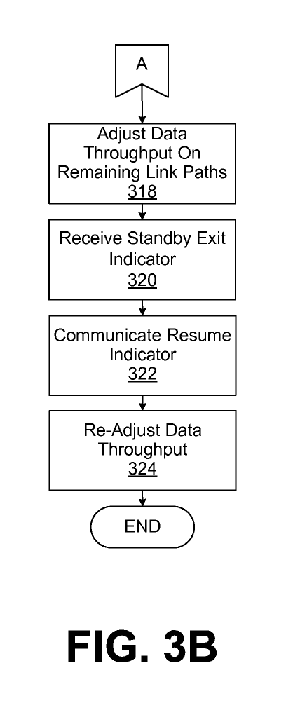

Before turning to the process flow diagrams of FIGS. 3A and 3B, it is noted that the embodiments described herein may be practiced using an alternative order of the steps illustrated in FIGS. 3A and 3B. That is, the process flows illustrated in FIGS. 3A and 3B are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope and spirit of the embodiments.

FIG. 3A illustrates a flow diagram for a process 300 of power state synchronization performed by the system 10 of FIG. 1 according to an example embodiment. At reference numeral 302, the process 300 includes operating a device as a group access point. With reference to FIG. 2 for example context, at reference numeral 302, the device 200 may be operated as a group access point or P2P group owner, based on a configuration of the device 200, as further described above. At reference numeral 304, the process 300 includes establishing, with the group access point, a network including a communications channel among a plurality of devices. As described with reference to FIG. 2, the network may include the link paths 240, 242, 250, and 252 among the devices 200-203 (and other link paths to other devices).

Referring back to FIG. 3A, the process 300 further includes receiving a standby entry indicator from a first device of the plurality of devices at reference numeral 306. With reference to FIG. 2, the standby entry indicator may be received from any of the devices 201-203, for example. At reference numeral 308, the process 300 includes estimating a time period needed to resume communications to the first device. With reference to FIG. 2, the P2P group owner device 200 may determine a relatively limited time period during which to buffer data for a device that is entering a standby mode of operation, so as to quickly restart data communication for the device after exiting the standby mode.

Turning back to FIG. 3A, the process 300 further includes buffering an amount of data for the first device based on the time period determined at reference numeral 308, at reference numeral 310. It is noted here that, the buffering at reference numeral 310 occurs before the transmission of any halt indicator. It is also noted that, in certain embodiments, the processes at reference numerals 308 and/or 310 may be omitted from the process 300.

At reference numeral 312, the process 300 includes determining a frame type for communication of a halt indicator. For example, it is noted that the device 200 of FIG. 2 may communicate a halt indicator to one or more of the devices 201-203 in one or more different types of frames, cells, packets, or other protocol standard communications units or metrics. The type of frame (or other standard communication unit) used to communicate a halt indicator may be determined based on a frequency of receipt of standby entry indicators by the group access point, for example, or according to other factors consistent with the embodiments described herein.

Turning again to FIG. 3A, depending upon the type of frame determined at reference numeral 312, the process 300 proceeds to either reference numeral 314 or 316. At reference numeral 314, the process 300 includes communicating a halt indicator to at least a second device of the plurality of devices using a frame type “X”. As described herein, the halt indicator indicates a halt of communications to the first device. The frame type “X” can be any suitable frame or unit type.

Alternatively, at reference numeral 316, the process 300 includes communicating a halt indicator to at least the second device using a frame type “Y”. The frame type “Y” can be any suitable frame or unit type different than the frame type “X”. As described above with reference to FIG. 2, for example, the “X” and “Y” frame types may be action and beacon frames, respectively, or any other suitable standard communication unit or package.

Turning to FIG. 3B, the flow diagram for the process 300 is further illustrated. At reference numeral 318, the process 300 includes adjusting data throughput on one or more communications link paths after communication of the halt indicator. With reference to the example of FIG. 2, the device 200 may adjust (e.g., increase, decrease, etc.) data throughput on any one or more of the link paths 240, 242, 250, and 252 among the devices 201-203, depending upon which of the devices 201-203 has entered a sleep mode of operation. In certain embodiments, the adjustment in data throughput may occur automatically based on available network access time or bandwidth identified at the network or transport layers, for example, of the devices 200-203, once certain communications have been halted.

At reference 320, the process 300 includes receiving a standby exit indicator from the first device. The standby exit indicator may be received, from one of the devices 201-203 of FIG. 2, for example. In response to the standby exit indicator, at reference numeral 322, the process 300 includes communicating a communications resume indicator. Here, the resume indicator indicates a resumption of communications to the first device. The communications resume indicator may be communicated in various types of frames and, in exemplary embodiments, the communications resume indicator may be communicated in the same type of frame used to communicate the halt indicator, for consistency.

At reference numeral 324, the process 300 includes re-adjusting data throughput on one or more communications link paths after communication of the resume indicator. With reference to the example of FIG. 2, the device 200 may re-adjust (e.g., increase, decrease, etc.) data throughput on any one or more of the link paths 240, 242, 250, and 252 among the devices 200-203, depending upon which of the devices 201-203 has exited the sleep mode of operation. In certain embodiments, the adjustment in data throughput may occur automatically based on available network access time or bandwidth identified at network or transport layers of the devices 200-203, once certain communications have been resumed.

As described herein, according to aspects of the process 300, the use of halt indicators may be particularly useful when devices in an ad-hoc network are not designed for buffering significant amounts of data. In this case, particularly, buffer overflow packet loss may be avoided. In addition to avoiding buffer overflow packet loss, communications channels may be more efficiently and effectively utilized according to aspects of the process 300. Generally, link paths must share communications resources in networks. In this case, any unnecessary data communications in a network (e.g., resulting in mere packet loss) may be considered a waste of communications resources in the network. On the other hand, if a P2P group owner device, for example, halts certain unnecessary data communications in a network, then data throughput over the remaining links may be increased.

FIG. 4 illustrates an example schematic block diagram of a computing architecture 400 that may be employed by one or more elements of the system 10 of FIG. 1 or one or more elements of the system 20 of FIG. 2, according to various embodiments described herein. The computing architecture 400 may be embodied, in part, using one or more elements of a mixed general and/or special purpose computer. The computing device 400 includes a processor 410, a Random Access Memory (RAM) 420, a Read Only Memory (ROM) 430, a memory device 440, and an Input Output (I/O) interface 450. The elements of computing architecture 400 are communicatively coupled via a bus 402. The elements of the computing architecture 400 are not intended to be limiting in nature, as the architecture may omit elements or include additional or alternative elements.

In various embodiments, the processor 410 may include any general purpose arithmetic processor, state machine, or ASIC, for example. In various embodiments, the access point 100 or the devices 130-133 of FIG. 1 may be implemented, at least in part, using a computing architecture including the processor 410. Similarly, the devices 200-203 of FIG. 2 may be implemented, at least in part, using a computing architecture including the processor 410. The processor 410 may include one or more circuits, one or more microprocessors, ASICs, dedicated hardware, or any combination thereof. In certain aspects and embodiments, the processor 410 is configured to execute one or more software modules. The processor 410 may further include memory configured to store instructions and/or code to perform various functions, as further described herein. In certain embodiments, the process 300 described in connection with FIGS. 3A and 3B may be implemented or executed by the processor 410.

The RAM and ROM 420 and 430 include any random access and read only memory devices that store computer-readable instructions to be executed by the processor 410. The memory device 440 stores computer-readable instructions thereon that, when executed by the processor 410, direct the processor 410 to execute various aspects of the embodiments described herein.

As a non-limiting example group, the memory device 440 includes one or more non-transitory memory devices, such as an optical disc, a magnetic disc, a semiconductor memory (i.e., a semiconductor, floating gate, or similar flash based memory), a magnetic tape memory, a removable memory, combinations thereof, or any other known non-transitory memory device or means for storing computer-readable instructions. The I/O interface 450 includes device input and output interfaces, such as keyboard, pointing device, display, communication, and/or other interfaces. The bus 402 electrically and communicatively couples the processor 410, the RAM 420, the ROM 430, the memory device 440, and the I/O interface 450, so that data and instructions may be communicated among them.

In certain aspects, the processor 410 is configured to retrieve computer-readable instructions and data stored on the memory device 440, the RAM 420, the ROM 430, and/or other storage means, and copy the computer-readable instructions to the RAM 420 or the ROM 430 for execution, for example. The processor 410 is further configured to execute the computer-readable instructions to implement various aspects and features of the embodiments described herein. For example, the processor 410 may be adapted or configured to execute the process 300 described above in connection with FIGS. 3A and 3B. In embodiments where the processor 410 includes a state machine or ASIC, the processor 410 may include internal memory and registers for maintenance of data being processed.

The flowchart or process diagram of FIGS. 3A and 3B are representative of certain processes, functionality, and operations of embodiments described herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 410. The machine code may be converted from the source code, etc. Further, each block may represent, or be connected with, a circuit or a number of interconnected circuits to implement a certain logical function or process step.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A communications method, comprising:
operating a device as a group access point;
establishing, with the group access point, a network including a communications channel among a plurality of devices;
receiving a standby entry indicator from a first device of the plurality of devices; and
in response to the standby entry indicator, communicating, by the group access point, a halt indicator to at least a second device of the plurality of devices, the halt indicator indicating a halt of communications to the first device.

2. The method of claim 1, further comprising:
in response to the standby entry indicator from the first device, estimating a time period to resume communications to the first device; and
before communicating the halt indicator, buffering, by the group access point, an amount of data for the first device based on the time period.

3. The method of claim 1, further comprising:
receiving a standby exit indicator from the first device; and
in response to the standby exit indicator, communicating, by the group access point, a communications resume indicator to at least the second device, the resume indicator indicating a resumption of communications to the first device.

4. The method according to claim 1, wherein:
the communications channel of the network includes a first link path between the second device and the group access point, and a second link path between the group access point and the first device; and
the network includes a second communications channel including a third link path between the second device and the group access point and a fourth link path between the group access point and a third device of the plurality of devices.

5. The method according to claim 4, further comprising increasing data throughput on the third link path and the fourth link path after communication of the halt indicator.

6. The method according to claim 1, further comprising determining a frame type for communication of the halt indicator based on a frequency of receipt of standby entry indicators by the group access point.

7. The method according to claim 6, wherein the frame type comprises an access frame or a beacon frame.

8. The method according to claim 1, wherein communicating the halt indicator comprises communicating the halt indicator to each of the plurality of devices.

9. A communications device, comprising:
a communications front end circuit; and
a processing circuit configured to:
establish a network including a communications channel among a plurality of devices;
receive a standby entry indicator from a first device of the plurality of devices; and
communicate a halt indicator to at least a second device of the plurality of devices, the halt indicator indicating a halt of communications to the first device.

10. The communications device according to claim 9, wherein the processing circuit is further configured to:
estimate a time period to resume communications to the first device in response to the standby entry indicator from the first device; and
buffer an amount of data for the first device based on the time period, before communicating the halt indicator.

11. The communications device according to claim 9, wherein the processing circuit is further configured to:
receive a standby exit indicator from the first device; and
communicate a communications resume indicator to at least the second device in response to the standby exit indicator, the resume indicator indicating a resumption of communications to the first device.

12. The communications device according to claim 9, wherein:
the communications channel of the network includes a first link path between the second device and the first device; and
the network includes a second communications channel including a second link path between the second device and a third device of the plurality of devices.

13. The communications device according to claim 12, wherein the processing circuit is further configured to increase data throughput on the second link path after communication of the halt indicator.

14. The communications device according to claim 9, wherein the processing circuit is further configured to determine a frame type for communication of the halt indicator based on a frequency of receipt of standby entry indicators in the network.

15. The communications device according to claim 9, wherein the processing circuit is further configured to communicate the halt indicator to each of the plurality of devices.

16. A computer-readable medium storing computer readable instructions thereon that, when executed by a processing circuit, direct the processing circuit to perform a communications method, comprising:
establishing a network among a plurality of devices;
receiving a standby entry indicator from a first device of the plurality of devices; and
communicating, by the processing circuit, a halt indicator to at least a second device of the plurality of devices, the halt indicator indicating a halt of communications to the first device.

17. The computer-readable medium of claim 16, wherein the method further comprises:
estimating a time period to resume communications to the first device; and
buffering an amount of data for the first device based on the time period.

18. The computer-readable medium of claim 16, wherein the method further comprises:
receiving a standby exit indicator from the first device; and
communicating, by the processing circuit, a communications resume indicator to at least the second device, the resume indicator indicating a resumption of communications to the first device.

19. The computer-readable medium of claim 16, wherein the method further comprises increasing data throughput on at least one link path of the network after communication of the halt indicator.

20. The computer-readable medium of claim 16, wherein the method further comprises determining a frame type for communication of the halt indicator based on a frequency of receipt of standby entry indicators.
